(19) United States
(12) Patent Application Publication
(10) Pub. No.: US 2019/0159617 A1
(43) Pub. Date: May 30, 2019

(54) DEVICE FOR THE METERED FILLING OF A DRINKING STRAW WITH A FILLING MATERIAL

(71) Applicant: Harro Hoefliger Verpackungsmaschinen GmbH, Allmersbach im Tal (DE)

(72) Inventors: Elke STERNBERGER-RUETZEL, Allmersbach im Tal (DE); Philipp GAUS, Allmersbach im Tal (DE); Michael ROEHRLE, Allmersbach im Tal (DE)

(73) Assignee: Harro Hoefliger Verpackungsmaschinen GmbH, Allmersbach im Tal (DE)

(21) Appl. No.: 16/200,879

(22) Filed: Nov. 27, 2018

(30) Foreign Application Priority Data
Nov. 30, 2017 (EP) 17 001 961.6

(51) Int. Cl. A47G 21/18; A61J 7/00

(52) U.S. Cl. CPC A47G 21/183; A61J 7/0038

(57) ABSTRACT

A device for the metered filling of a drinking straw with a filling material includes a material store as a storage container for the filling material. An opening is present in the base of the material store, the opening discharging from above into a compressed air channel. A closure device is provided for sealing the compressed air channel relative to the material store. At least one receiving unit is present for receiving at least one drinking straw, so that the at least one drinking straw is able to be positioned with its upper edge region on the end of the compressed air channel on the air outlet side.

### CROSS REFERENCE TO RELATED APPLICATIONS

Applicant claims priority under 35 U.S.C. § 119 of European Application No. 17 001 961.6 filed Nov. 30, 2017, the disclosure of which is incorporated by reference.

### BACKGROUND OF THE INVENTION

### 1. Field of the Invention

The invention relates to a device for the metered filling of a drinking straw with a pourable or flowable filling material. Such devices are used, in particular, when producing nutritional supplements or medicaments. In these cases, a filling material containing an active substance is filled into a suitable container so that the filling material and thus also the active substance may be swallowed, for example, as a capsule.

### 2. Description of the Related Art

Depending on the type of metering, two main groups of preparations of active substances are known. Firstly, the active substance may already be correctly pre-metered, for example in the form of tablets, filled hard gelatine capsules or injection ampoules. In this case, each unit of the preparation already contains the correct, predetermined dose of the active substance. Secondly, preparations exist in non-metered form from a reservoir (container), for example in the form of ointments, powders, granules or pellets. In this case, the respectively required quantity of product and thus also of active substance is taken individually. If the respective active substance has a large therapeutic window, the patient and/or consumer may take such an individual dose directly. If the active substance, however, has only a very narrow therapeutic window—i.e. the boundary between a dose which is as yet ineffective and a dose which already causes undesirable side effects is very small—the patient should no longer take the active substance individually in an uncontrolled manner.

Preparations comprising pre-metered active substances are produced, in particular, on an industrial scale when the respective dosage is to be provided in a large quantity. This is the case, for example, for antibiotics. Other treatments, however, require a dosage which is individual to the patient and which, for example, relates to the respective body weight. In this case, industrial production is generally cost-intensive and thus economically inefficient. Thus individual metering is generally performed in the pharmacy or hospital pharmacy. For example, a series of oncology drugs and psychotherapeutic drugs has to be metered individually. Specifically in geriatrics and paediatrics, relatively conventional medicaments such as antibiotics frequently also have to be metered individually. This is required in order to take account of the differences in body weight and in physical condition and in some cases also in order to take account of the specific metabolism in small children.

When metering an active substance to be individually dispensed to a patient, this is generally weighed out in the hospital pharmacy. Alternatively, a specific volume of the active substance which corresponds to the required dose of the active substance may also be measured out. In order to simplify the intake for the patient, the individual dose is frequently filled into hard gelatine capsules. Such capsules which are assembled from a capsule lower part and a capsule upper part are a common means of administering powdery or pellet-shaped active substances. They may be produced and filled on an industrial scale in very large quantities but may also be used in pharmacies for producing separate individual doses.

Nowadays, drinking straws are also used for administering active substances and/or food supplements. Such a drinking straw is disclosed, for example, in EP 1 843 683 B1. The active substance is present, in particular, in this case in the form of granules, pellets, microtablets or powders, and preferably has a size in the range of approximately 250 micrometers up to 4 millimeters. The average size in this case is approximately 250 micrometers up to 710 micrometers. The active substance in this case is already located in the drinking straw and preferably is suctioned with a liquid from the drinking straw into the mouth of the patient and subsequently swallowed. This makes it easier for the patient to take the active substance since generally the active substance may be swallowed much more easily. This may be advantageous, in particular, in patients with swallowing difficulties (for example in paediatrics and/or geriatrics). By taking the active substance as an in situ suspension with the liquid, the taste of the active substance, for example, may be masked by the liquid. The patient may adapt the taste as desired by different beverages. With the use of pellets these are generally functionally coated. In this manner, a masking of the taste may also be possible. Moreover, a specific release profile may also be obtained. The drinking straws are generally produced on an industrial scale and, therefore, contain an accurately predetermined dose of a medicament.

### SUMMARY OF THE INVENTION

Proceeding from this already disclosed prior art, the object of the invention is to provide an improved device for the metered filling of a drinking straw with a filling material containing an active substance, which in particular permits individual filling of the drinking straws in pharmacies and/or hospital pharmacies. In this case, in particular, smaller quantities of drinking straws are designed to be able to be filled cost-effectively, rapidly and reliably.

The device for the metered filling of a drinking straw with a filling material is provided by the features according to the invention. Expedient developments of the invention form the subject-matter of further embodiments discussed below.

The device for the metering filling of a drinking straw with a filling material containing an active substance comprises a material store as a storage container for the filling material to be filled. An opening is present in the base of the material store, said opening discharging from above into a compressed air channel. The compressed air channel may be sealed relative to the material store by means of a closure device. According to the invention, at least one receiving unit is present for receiving at least one drinking straw. Through this receiving unit, the at least one drinking straw may be positioned with its upper edge region on the end of the compressed air channel on the air outlet side.

After opening the closure device a defined quantity of filling material may fall out of the material store into the compressed air channel. Subsequently, the filling material which is located in the compressed air channel after closing the closure device may be transported by means of gas pressure surges through the compressed air channel. This type of conveyance of filling material is particularly gentle so that the filling material is not damaged during transport. Thus coated pellets may also be reliably filled. The upper edge region of the drinking straw into which the filling material portion is able to fall is positioned at the end of the compressed air channel.

The drinking straw in this case should already be sealed by suitable means at its lower end, so that the filling material may not fall out of the drinking straw. After removing the drinking straw from the device, said drinking straw may be closed by means of a separate cap. By the device according to the invention, therefore, for the first time an individual filling of small quantities of drinking straws is possible. This permits new fields of application of the drinking straw when administering active substances to patients.

In order to facilitate the removal of the filled drinking straw and the provision with a new empty drinking straw, the at least one receiving unit may be releasably fastened to the device. The receiving unit may, therefore, be removed from the device in order to be able to handle the drinking straws more easily. In this manner, the drinking straws may be inserted from above into the receiving unit. This permits a secure position of the drinking straws inside the receiving unit and at the same time easy handlability of the receiving unit and the drinking straws.

The at least one receiving unit may preferably be fixed in position by means of a fastening unit. By means of the fastening unit, therefore, an accurate alignment of the receiving unit and thus also of the drinking straw may be ensured. As a result, it may be ensured that the filling material may be optimally filled into the drinking straw and a portion of the filling material does not inadvertently fall to the side of the drinking straw.

In a preferred embodiment in terms of structure, the fastening unit may comprise at least one latching element. In particular, the fastening unit may comprise at least one latching lever which may engage in a recess in the region of the receiving unit. If the fastening unit has only one individual latching lever, this latching lever, for example, may engage in a central recess of the receiving unit. If the fastening unit has two latching levers, however, these latching levers may encompass the receiving unit and engage with their latching lugs in two lateral recesses of the receiving unit.

In a particularly preferred embodiment, a monitoring element may be present, the correct position of the receiving unit being able to be monitored thereby. In this case, for example, the monitoring element could also ensure that the material store may not be opened if the receiving unit is absent or incorrectly inserted. As a result, it may be prevented that filling material is inadvertently removed from the material store without the drinking straw being in the correct position at the end of the compressed air channel. The monitoring element could, for example, comprise an electrical contact which is activated when the receiving unit is inserted correctly. To this end, the electrical contact could be arranged, in particular, in the region of the fastening means of the fastening unit.

The device according to the invention is suitable, in particular, for filling small quantities of drinking straws. The device according to the invention, therefore, may be used in particular in pharmacies or hospitals, in order to fill the quantity of active substance required individually for a patient into a drinking straw.

The gas pressure surge required for the transport of the filling material through the compressed air channel may, in particular, be configured as an air pressure surge. The gas pressure surge may be set in any manner in terms of its pulse width and its pressure level, wherein the pulse width and the pressure level in principle are independent of one another.

Preferably, the device according to the invention may have a weighing unit. The weight of the filling material which has been filled in may be accurately determined by the weighing unit. The weighing unit could in this case measure the weight of the filling material still located in the material store and/or the weight of the filling material already located in the container. In a particularly preferred embodiment, a printer unit may additionally be present. A subsequent automatic record-keeping of the filling procedure is possible by means of the printer unit.

The device according to the invention is not limited to any specific type of filling material. In principle, any material may be regarded as filling material provided it may be divided into units which all have substantially the same quantity of active substance. This is the case, in particular, of such solid materials which are present in the form of granules, pellets or microtablets. In principle, liquids may also be correspondingly metered, in particular when these liquids are present in the form of microcapsules. The invention is of significance, in particular, in the case of filling materials with high-value active substances, so as not to drive up costs unnecessarily for a treatment. An individual filling of the respectively required doses may also be advantageous in the case of active substances with a short storage life.

Further advantages and features of the invention are to be derived from the features also set forth in the claims and the following exemplary embodiments.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a schematic longitudinal section through a first embodiment of the device according to the invention;

FIG. 2 shows a schematic side view of the receiving unit of a second embodiment of the device according to the invention; and

FIG. 3 shows a schematic cross section through the receiving unit according to FIG. 2.

### DETAILED DESCRIPTION OF PREFERRED EMBODIMENTS

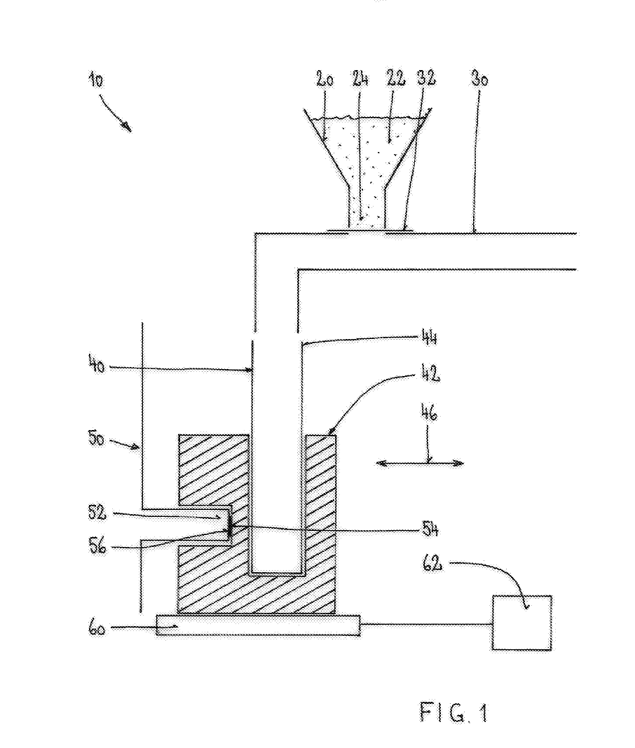

A first embodiment of the device 10 according to the invention is shown schematically in FIG. 1. The device 10 comprises a material store 20 in which a filling material 22 is held in storage. The filling material 22 in the present exemplary embodiment is in the form of pellets which in each case contain a defined quantity of an active substance. Thus a uniform distribution may be achieved of the concentration of the active substance in the filling material 22.

An opening 24 is present in the base of the material store 20. The opening 24 discharges from above into a compressed air channel 30. The opening 24 may be closed by means of a closure device 32, so that the compressed air channel 30 is sealed relative to the material store 20. If the closure device 32 is open, a defined volume of filling material 22 may fall into the compressed air channel 30. The filling material 22 already located in the compressed air channel 30 prevents the continued flow of further filling material 22. Subsequently, the closure device 32 may be closed again. By means of one or more gas pressure surges the filling material located in the compressed air channel 30 may then be moved along the compressed air channel 30 until the filling material reaches the end of the compressed air channel 30. At the end of the compressed air channel 30 the filling material falls into the drinking straw 40 located there.

The drinking straw 40 is mounted upright in a receiving unit 42, so that the upper edge region 44 with the opening of the drinking straw 40 faces upwardly in the direction of the compressed air channel 30. In order to remove the drinking straw 40 after filling and to replace it with a new empty drinking straw 40, the receiving unit 42 may be removed from the device 10 in the direction of the arrow 46. After the removal of the receiving unit 42 the drinking straw 40 may be pulled from above out of the receiving unit 42. Subsequently, the receiving unit 42 may be provided with a new drinking straw 40 and positioned again in the device 10.

In order to ensure that the receiving unit 42 and thus also the drinking straw 40 to be filled are located at the correct position, in the present example the device 10 has a fastening unit 50 in the form of a latching lever 52. The latching lever 52 in the correct position of the receiving unit 42 penetrates into a recess 54 of the receiving unit 42. A monitoring unit in the form of an electrical contact 56 is present at the base of the recess 54. Only if this electrical contact 56 is contacted by the latching lever 52 is the drinking straw 40 able to be filled. This may be ensured, for example, by an opening of the closure device 32 only being possible at this time. Alternatively or additionally, the gas pressure supply may also be stopped if the electrical contact 56 is not yet contacted by the latching lever 52. Thus with an inadvertent actuation of the device 10 without the receiving unit 42 being inserted (for example when transporting or cleaning the device 10) it is also impossible that valuable filling material 22 is able to be removed from the material store 20.

In the present example, the filling of the drinking straw 40 with filling material 22 may be monitored by means of a weighing unit 60. To this end, the receiving unit 42 is located on the weighing unit 60. Alternatively or additionally, the weight of the material store 20 and thus the removal of the filling material 22 from the material store 20 could also be monitored by means of a weighing unit. The weighing unit 60 in the present case is connected to a printer unit 62 so that the measurement result may be emitted and recorded via the printer unit 62. In contrast to the exemplary embodiment shown here, the weighing unit 60 and/or the printer unit 62 could also be dispensed with.

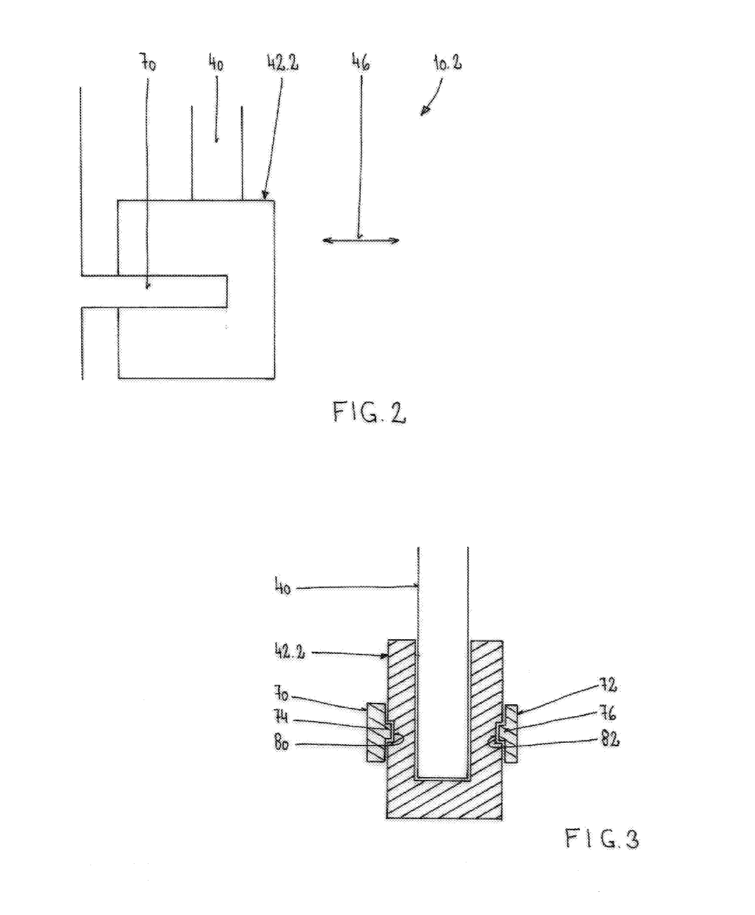

A second embodiment of the device 10.2 according to the invention is shown in FIGS. 2 and 3 without the compressed air channel 30 and the material store 20. The receiving unit 42.2 of the device 10.2 according to FIG. 3 is fastened by means of two latching levers 70, 72 to the device 10.2. The two latching levers 70, 72 laterally encompass the receiving unit 42.2 and engage with their latching lugs 74, 76 in each case in lateral recesses 80, 82 of the receiving unit 42.2.

Although only a few embodiments of the present invention have been shown and described, it is to be understood that many changes and modifications may be made thereunto without departing from the spirit and scope of the invention.

What is claimed is:

1. A device (10) for the metered filling of a drinking straw (40) with a filling material (22), the device comprising:
a material store (20) as a storage container for the filling material (22);
an opening (24) in the base of the material store (20), said opening discharging from above into a compressed air channel (30); and
a closure device (32) for sealing the compressed air channel (30) relative to the material store (20);
wherein
at least one receiving unit (42) is present for receiving at least one drinking straw (40); so that
the at least one drinking straw (40) is able to be positioned with its upper edge region (44) on the end of the compressed air channel (30) on the air outlet side.

2. The device according to claim 1, wherein the at least one receiving unit (42) is able to be releasably fastened for receiving the at least one drinking straw (40) on the device (10).

3. The device according to claim 2, wherein the at least one receiving unit (42) is able to be fixed in position for receiving the drinking straw (40) by means of a fastening unit (50).

4. The device according to claim 3, wherein the fastening unit (50) comprises at least one latching element (52).

5. The device according to claim 4, wherein
the fastening unit (50) comprises at least one latching lever (52); and
for receiving a drinking straw (40) the receiving unit (42) comprises at least one recess (54) for the latching lever (52).

6. The device according to claim 2, wherein a monitoring unit (56) is present, the position of the receiving unit (42) being able to be monitored thereby.

7. The device according to claim 1, wherein a weighing unit (60) is present.

8. The device according to claim 7, wherein a printer unit (62) is present.
